(19) United States
(12) Patent Application Publication
(10) Pub. No.: US 2014/0310289 A1
(43) Pub. Date: Oct. 16, 2014

(54) DATA ANALYTICS WITH NAVIGATION (DAWN) USING ASSOCIATIONS BETWEEN SELECTORS (TERMS) AND DATA ITEMS

(71) Applicant: SPEEDTRACK, INC., Yorba Linda, CA (US)

(72) Inventors: Jerzy Josef Lewak, Del Mar, CA (US); Pawel Grzes, Krakow (PL)

(73) Assignee: SPEEDTRACK, INC., Yorba Linda, CA (US)

(21) Appl. No.: 14/251,487

(22) Filed: Apr. 11, 2014

Related U.S. Application Data
(60) Provisional application No. 61/811,006, filed on Apr. 11, 2013.

(51) Int. Cl. G06F 17/30

(52) U.S. Cl. CPC G06F 17/30522; G06F 17/30342
USPC 707/750

(57) ABSTRACT

Systems and methods are described which use associations between field values, more generally terms, called selectors, and data items, or structures within data items. The associative information is derived from the content of data and can be stored in optimal data structures, generally descriptively named associative matrices, which may be used to perform searches and calculations of data analytics. In some embodiments, calculations use only selector values and their counts, called frequencies, of associated data items, and/or structures within those items. Special queries, executed on the associative information, determine the frequencies. Methods of data analysis use the results of these queries. Applications can display results dynamically as a user creates queries by choosing selectors, changing the queries, and creating new ones, completely intuitively, using point and click. By comparing the results of multiple queries, such an application enables users to dynamically and quantitatively explore associations between facet values.

### CROSS REFERENCE TO RELATED APPLICATIONS

This application claims the benefit of the filing of U.S. Provisional Patent Application No. 61/811,006, filed on Apr. 11, 2013, the disclosure of which is incorporated by reference herein.

### BACKGROUND OF THE INVENTION

The present invention relates generally to database operations, and more particularly to performance of calculations on data.

Software applications which deal with data have evolved from the beginning days of the personal computer. Perhaps the two most commonly used applications, which deal with data, are a Relational Database and a Spread-Sheet. Databases have evolved to support data storage, transactions, and search queries. Spread-Sheets have focused on supporting analysis of data using calculations. Support for a large number of Spread-Sheet features has hampered the ability of a Spread-Sheet to analyze large data sets. Whereas current relational databases can handle hundreds of millions to many billions of records, the latest Microsoft Excel spread sheet has a limit on the number of rows. This is extremely limiting when calculations are needed on large datasets. In such a large dataset, usually analysis is performed by applications built specifically for the purpose, because removing the limit in a spread sheet and performing the calculations there, would probably be very slow and resource demanding.

Databases of various kinds store and search data, but are not convenient or as flexible as spreadsheets for calculations. Calculations are therefore often performed in applications separate from the database, or as added functionalities. Such applications are often designed to communicate with the database and use its search results to carry out the calculations on subsets of the data. Such an arrangement is both slow and inconvenient. It is slow because the queries often result in a large data set and so can take some time to execute. It is inconvenient because creating a query usually requires the use of SQL, something that is difficult and time consuming for those who need the results of the analysis. Furthermore adjustments to the chosen data subset often need to be made and this often requires a change of the query and another search.

For example, suppose that after the results of an analysis, based on a subset of the data resulting from a query, are examined, the subset of the data needs to be changed. The user has to adjust the SQL query, which means another search and the attendant delay. Then the analysis needs to be re-done, all resulting in delays. If the data resulting from two separate queries, needs to be compared, the process is even more involved and takes longer.

### BRIEF SUMMARY OF THE INVENTION

Aspects of this invention relate to the methods of integrating functionality of a database and a spread-sheet. However, the functionality of the relational database has some serious well-known problems. Therefore although this functionality may be integrated into existing relational databases, its integration is more easily performed on a database system using the new Technology for Information Engineering (TIE) with a Guided Information Access (GIA) user interface, or on the Faceted Navigation or Faceted Search systems. It can also be implemented in any database system which can be scripted or modified to provide the needed optimal associative matrices.

Aspects of the invention may also relate to a method which enables calculations, based on associative data and special queries, to be responsive in real-time to changes of the special queries. Further aspects of the invention relate to supporting the functioning of an intuitive user interface for those wishing to perform calculations, similar to those currently performed in spread-sheets, based on data. Such functionality integration of database functions with those of spread-sheets, leads to applications which can be interactive, efficient and intuitive, allowing any user who needs to explore the data, with very little training, to navigate through the information simultaneously performing calculations. Queries can be defined and modified with just a few mouse clicks. Information of associations relevant to a current query can be shown immediately after each query adjustment and made available for narrowing or broadening user choices. In addition such methods typically display the results in the form of selector lists with associated calculated values for each selector in multiple columns. This has great advantages: the user can track the results while adjusting the query and by sorting the rows by calculated values, the user can choose to pick the most significant or interesting subset of data.

For example, in a database of a large number of hospital patient encounters, sorting the list of hospital name selectors by their frequency allows us to see and pick hospitals with the largest number of encounters. If we narrow the list to encounters involving just one medical procedure (in TIE with a GIA GUI, this involves a single click on the medical procedure name or code) the list of hospitals immediately shows those with the largest number of such procedures. Change the procedure and the hospital list adjusts appropriately. More complicated analysis is also fast and relatively simple with visible, interactive, incremental progress.

These and other aspects of the invention are more fully comprehended upon review of this disclosure.

### BRIEF DESCRIPTION OF THE FIGURES

FIG. 1 is a flow diagram of a process for creating a calculated column in accordance with aspects of the invention.

### DETAILED DESCRIPTION

Calculations on numerical field values, or any parts of data, generally termed selectors, may use selector values and the counts of records, or in general entities or items, associated with each selector. Each such count is called a frequency of the associated selector. Standard relational databases require special queries to evaluate such frequencies. The creation of a suitable indexing system, such as matrix-like structures indexed using integer identifiers of elements, used in TIE implementations, can expedite the responses to such complex queries. Technology for Information Engineering (TIE) systems and faceted navigation systems often evaluate frequencies as part of the information navigation features, which replace the usual search features. Such frequencies and the associated selector values can be used in calculating the values in columns.

For example, if each item represents a customer's transaction with an amount of that transaction as a selector, then a query for the count of all items, with a particular amount in the respective field, will show the count of items. The total revenue from a particular amount will be the product of the amount's frequency and the amount. The total of all such products is the total revenue. Frequencies for all selectors can be obtained by using a special query which checks each selector value and counts the number of matching items. Performing such a query for each selector is a very inefficient method of determining the frequencies. Using an efficient way to store the associations between selectors and items and creating search applications using special data structures which take full advantage of their efficiency, can enable the calculation of frequencies of every selector in just one efficient query, even when the number of selectors is in tens of millions or more.

Associations between items and selectors can be visualized as a binary matrix where each row number is the identifier of an item and each column number is the identifier of a selector. A zero in a cell of the matrix means no association between the respective item and selector whereas a 1 in a cell represents an association between the respective item and selector.

The structure of the association between selectors and items is a bi-partite simple graph where selectors are adjacent to items. In more complex data, additional partites are added. For example when items have structure comprised of a plurality of entities of the same kind within an item, an entity layer may be added between selectors and items and this structure can be graphed as a tri-partite simple graph, where the selectors are adjacent to the entities and the entities are adjacent to the items.

Queries which request a response of association frequencies are more exacting than those which only need the identification of the matching items. When items are comprised of identifiable entities, counts of these entities associated with each selector can also be useful and are called entity frequencies of selectors. Similarly when the context makes it clear whether entity or item counts are involved, or in statements where either one could apply, the simpler term selector frequency is used.

Selector frequencies, resulting from a query, are usually calculated in two steps. The first step is the usual one of identifying the matching items, or entities. The second step, which we call the reverse query which usually iterates through the matching items, or entities, must determine the count of matching items, or entities associated with each selector.

One aspect of this invention is the ability to perform analysis of information using only the association matrices, without ever needing the actual data. Because the matrices can be implemented in universal optimal structures, independent of the nature of the data, their program structures and the methods used in evaluating queries can be optimized once and for all, providing very fast response times. Fast query response times allow real-time interactive analysis of data using guided navigation through the information and immediate adjustment of calculations.

Notation and Calculation Parameters

In order to illustrate the various processes and methods, we introduce the following notation.

Each query is represented by Q with a suffix which associates with particulars of the query. The set of frequencies of every selector are represented by f which with a suffix represents an individual frequency in the set associated with a particular selector referenced by the suffix. The set of selectors is represented by the symbol S which with a suffix represents an individual selector, member of the set, referenced by the suffix. A query usually limits the matching data to a subset of all the data. A null or empty query, designated by Q₀, makes all the data the matching data and in particular it makes available the frequencies of all the selectors in all the data. Calculations use the frequencies of selectors and the selector values themselves when they are numeric. In general f depends on the query which we indicate by writing f(Q). More specifically, the frequency associated with selector i when the query is Q, is fᵢ(Q).

Queries can be represented as Boolean expressions comprising selectors. When queries are combined, their product represents their conjunction and their sum their disjunction.

In a group with numeric selectors, a common calculated value for each selector is the product of the selector value Sᵢ and its frequency fᵢ. We will refer to that product as the revenue and use the symbol R, even though it may represent other things than revenue such as for example: cost. So that for each selector i in a numeric selector group we have the simple relation: Rᵢ=Sᵢfᵢ.

The total T, average A, standard deviation σ, median, minimum, maximum, and sometimes even the geometric mean, of all the frequencies in a group, are sometimes useful results of the calculations. Any or all of these will be referred to as aggregates.

Example Calculations

Market Share.

A simple example is the calculation of the market share of each facility providing a particular service to a community, using counts of customer encounters as the measure. Assume the database contains data about a number of facilities, each providing a number of services to customers from different regions. Each item (which in a database could be a record or a join of records) would represent an instance of a service encounter with a customer. Each item would contain a number of fields or dimensions, each describing a facet of the encounter. The following is an example of a small subset of possible facets:

1. Facets of each facility
1.1 unique name or identifier
1.2 location

2. Facets of service performed
2.1 date
2.2 revenue amount
2.3 how paid
2.4 service performed

3. Facets of the customer
3.1 location
3.2 other customer details

4. Other information

Each facet or field may be generalized and called a group and each of the unique values in a group is a selector. A common display lists the selectors under each group's name. We will assume that in each group, the list of selectors would associate each selector with a frequency in a frequency column. Aggregates of all the frequencies may also be calculated and available for other calculations and can be displayed at the top or bottom of the list of selectors. Additional columns of other derived calculated values can also be displayed.

So for example in the Revenue Amount group the selectors are numerical and in addition to the frequency column a second column may be used to display, for each selector value, the product of the selector value and its frequency. Other columns can be used for other derived calculated values. Aggregates of each column may similarly be displayed at the top or bottom of each column. Queries are created by choosing selectors in Boolean combinations and following evaluation of a query, numerical columns and statistics are updated.

Market Share in a Region.

This can use a query limiting the data to the region of interest, for example by a zip-code value, choosing the selector S_{z} from the zip-code group to create the query Q_{z}. Following the region defining query, the measure of the market share of each facility in the region is obtained by dividing each facility's frequency, fᵢ, by the total of all encounters at all facilities in the region, T(Q_{z}), that is the total of all frequencies in the facilities listing group resulting from the query Q_{z}. This market share measure, fᵢ/T(Q_{z}), can be displayed in another column and can be shown as a percentage.

Market Share in a Region and a Service Type. A similar market share measure of each facility, but only for one service type, Sₛ, would use the results of the limiting query obtained by conjunctively adding the selector designating the service type, Sₛ, to the selector query defining the region, giving the query Q_{sz}=S_{z}Sₛ. The result of this query would give, for each facility, the frequency of items that match the query. Each such frequency, fᵢ, divided by the total of all such frequencies in the facilities group, would be the market share for each facility fᵢ/T(Q_{sz}).

The list of all participating facilities (that is facilities with non-zero frequencies) matching each query can be presented to a user with corresponding frequencies in one column and the ratio, representing the market share, in another column, optionally expressed as percentages. A user can then choose to sort that list by the market share to determine the market share ranking of each facility.

Market Share Based on Revenue.

Another calculation can also be developed using a revenue measure of market share. Limitations to region, service or anything else are in general controlled by the limiting query Qₗ which can comprise a plurality of selectors and Boolean operators. We need to determine the ratio of each facility's total revenue to all facilities' total revenue. All facilities total revenue is one of the aggregates in the revenue group and the revenue column. Each facility's total revenue needs a separate facility query, Q_{f}, consisting of the facility selector. The needed total revenue for a facility is the total aggregate in the revenue column in the revenue amount group, when the combined query QₗQ_{f} is applied.

If we need the market share of just one facility with selector S_{f}, we need a response to a query which conjoins the facility selector S_{f} with Qₗ, which will define and limit the items to the kind of services, the region, and any other selectors we wish to consider. The query consisting of just the facility selector we designate as Q_{f}. The query consisting of the conjunction of Qₗ and Q_{f} will be represented as the product QₗQ_{f}.

In the revenue group, the response to any query would comprise a list of each unique revenue amount and its frequency. From this list the total of the products of each amount and its frequency would be the total revenue as limited by any narrowing query. Designate the total revenue for a query Qₗ as R_{T}(Qₗ). Then the market share of facility S_{f} limited to the line item l is R_{T}(QₗQ_{f})/R_{T}(Qₗ), where Q_{f}=S_{f}. This needs the evaluation of the total revenue R_{T} for two queries (R_{T}(QₗQ_{f}) and R_{T}(Qₗ)) for one facility. If we want the market share for N facilities, each for the same line item query, we need N+1 queries, N for the facilities and one for the line item. We can name such sets of queries as looping queries because they involve an iteration loop through a query for each non-zero frequency selector in a group. In this example, the looping group is the facilities group.

Any number of variations of similar calculations can be performed, using only the results of frequencies and values of selectors. For some calculations only frequencies obtained as a result of a single query are needed. For others, a plurality of queries may be needed in order to compare frequencies resulting from different queries. Queries used in calculation that are not the current query, are referred to as comparison queries. In the last example Qₗ is the comparison query and R(Qₗ) the total revenue of all facilities, is derived from the result of this query.

Market Share of a Service.

The above example illustrates a case where the denominator obtained from the comparison query, is the same for every facility. In the next example, the denominator will be different for each selector. In both examples the denominator is obtained from a comparison query.

Suppose we want to compare the number of encounters at each facility for a service s, as a fraction of all encounters at the facility. Call this the market share service fraction. The comparison query in this case is the null query Q₀. The service fraction of each facility is the frequency fᵢ(Q₀) of each facility selector i, divided by the same selector's comparison frequency fᵢ(Qₛ) where Qₛ is the limiting query choosing the set of encounters providing the service s. Therefore the market share of service s for each facility selector i is fᵢ(Qₛ)/fᵢ(Q₀). fᵢ(Q₀) is always available, for every selector i, at startup, so the market share of each facility for a service needs the frequency results of only one query.

As this example indicates, one comparison query, sometimes needed for frequencies to compare with the narrowing query frequencies, is the null query Q₀, that is the completely empty query. This determines the frequencies of every selector for the whole un-narrowed database of items. These frequencies can be calculated at start-up of the server or after a transaction update (when a client-server version is used) and can be pre-cached on the server or the client so they can be quickly accessed. Other comparison queries are useful in comparisons of frequencies derived from a current query with those derived from the comparison queries. Sometimes multiple comparison queries are used to calculate certain results.

In this disclosure, a single query means a query whose matching items form a single set and multiple queries mean queries whose matching items form multiple sets. Two queries are considered the same when they have the same logical meaning.

Generalizations

The above examples show us how all calculations involving values associated with subsets of data can be carried out in terms of queries which can be evaluated using the association matrices. The evaluations involved in data analysis can use the following two types of queries:

A single query, which is the query that is used to display the end results of calculations. We will call this the limiting query. This can be any query including the null query. It narrows the items to those we wish to use for the analysis.

One or more comparison queries, whose results are used, together with the results of the limiting query, in calculations.

Each type of analysis gives calculated results for each selector in a group, with the selectors narrowed by the limiting. Each type uses the results of a limiting query and may use the results of other queries.

In each group there are two types of results from each query. One gives the aggregates and the other provides a value for each selector in the group. Usually this value is the selector frequency, but sometimes it may be a value obtained using the selector frequency and the selector value, or a value derived from another query.

The following are the common aggregates of the selector frequencies, selector values or any values associated with a selector.
1. Total
2. Average
3. Median
4. Maximum
5. Minimum
6. Geometric mean
7. Standard deviation

Other aggregates can sometimes be useful. We classify queries into the following types:

Narrowing Query:

a query narrowing the data items to those on which the results of the analysis are calculated.

Comparison Queries:

one or more queries the results of which are used in calculations, in conjunction with the results of the Narrowing query.

The Null Query:

the empty query, the results of which are the initial frequencies of each selector. These results can be used as a comparison query, in calculations with the results of the narrowing query, so this is just a special comparison query.

Analyses can be classified into five different types, each needing results of the limiting query and in addition the results of one or more of the following queries:

Type 1. The null query only, either each selector's frequency and/or one or more aggregates from any group.

Type 2. Aggregated results from one or more comparison queries.

Type 3. Individual selector frequencies from one or more comparison queries in a group.

Type 4. Results of a separate query for every selector in a group, which needs looping queries.

Type 5. More complicated queries involving more than one loop.

These possibilities cover most of the calculations needed in analyzing data.

Examples Using Hospital Encounters Data

Consider data comprising details of about 65 million encounters with patients at all hospitals and other health care facilities in California over several years. The data of each encounter includes about 200 fields a few of which are the following:
1. Facility name
2. Facility zip code
3. Patient zip code
4. Diagnosis
5. Procedure
6. Outcome
7. Cost amount
8. Paid amount

Under each field name is a list of all the field values in the data. We will call that the field value list, or simply the list. An objective of this invention is an application of query based calculation methods in a way that allows interactive navigation through information and through derived calculations. Examples already described and the following examples provide an illustration of the more general procedures and methods which can be used in such applications.

An application providing information navigation displays, may list all field values under each of the field names. It also can display the frequency associated with each field value. The process of navigation involves allowing a user to incrementally, in real time, build a query by adding selectors taken from lists, to a Boolean expression (in this example selectors will be mostly field values). The query response comprises information needed to access the matching items and the frequencies of each of the selectors in specified fields, or in all fields. The null query is the empty query, which means that all data is accessible, all field values can be listed with their associated null query frequencies.

The list of field values in each field can be sorted either alphanumerically, or by frequency. So for example in the Facility name field, the list of names can be sorted by frequency, showing first the facility with the highest frequency, i.e. highest number of encounters. Similarly in other field value lists.

When an application starts, there is no query, or put another way there is the null query the result of which is a list of all field values with the frequency of each. These null query frequencies can be cached and used in any calculations that make use of them.

Suppose that it is intended to calculate, for each facility, a measure of the quality of outcome for a particular medical procedure. One such measure could be the ratio R of the number of good outcomes G divided by the number of all such procedures P at each facility, which means the ratio R=P/G is the fraction of all procedures that result in a good outcome. P being the denominator of the ratio means we need to get the frequencies of all such procedures first. These would be the result of the query that chooses the particular procedure selectors from the procedure field or dimension. The procedure could be defined by a single selector (for example: hip replacement) or by a number of selectors combined as alternatives by the OR disjunction (for example: hip replacement OR knee replacement). The result of that query would provide the frequencies of all selectors in the facilities field, each being the P for each selector and so the denominator in the measure for each facility. This query would be chosen by a user as a comparison query and so could be temporarily saved to RAM or disk.

The next query would add (conjunctively) selector or selectors from the outcome field which define what we consider a good outcome (such as for example routine release). The result of this query changes the frequencies of all the selectors in the facilities group to those appropriate to the good outcome. In particular, the frequency of each facility, in the facilities field, would represent the number of good outcomes. To get the measure of good outcomes, each selector's frequency in the facilities group would be divided by that same selector's comparison query frequency and the result could be shown in a column as decimals, as percentages, or some other way next to a column of comparison query frequencies, each of which is the number of the defined procedures at the respective facility. Some facilities will have very few such procedures and so our confidence in the good outcome measure would be small. We can sort the list of facilities by the total number of the defined procedures and choose from it only those facilities which have performed more than some number of such procedures. The listed facilities can then be sorted by the good outcome measure, showing the highest rated facilities.

Column Evaluation Method

In the following description of calculating useful results in columns, it is not intended to limit the resulting calculated columns to their display on a display medium. It is equally possible to use the methods described to calculate such columnar results and present them to another computer program for further processing or conveyance to other devices or applications. The word column is used as a visualization of an array of numbers, each number associated with a selector.

Each column value to be displayed in a group can be defined in terms of one or more Column Defining Queries. The frequency of each selector in the group, resulting from each query, can be stored in an array of arrays which can be visualized as a table of rows and columns, referenced as the Column Defining Table. So for example each row number would be simply related to the ID number of a selector in the group and each column would be associated with each Column Defining Query. In terms of the array, each selector's integer ID can be used as the index of the array (with a possible offset) and each element of the array can be an array, with one element for each query. This means that the result of multiple queries can be stored in a table (array of arrays) with each row corresponding to a selector and each column corresponding to a Column Defining Query.

A function of selector frequencies for each Column Defining Query is chosen by the user and is referred to as the Column Defining Function. The function can be expressed in terms of mathematical operations on the symbols representing the Column Defining Queries, with additional symbols representing such parameters as total number of matching items, total of frequencies in a column, and aggregates of these.

More precisely, let Qᵢ represent the i^{th} Defining Query for some column, where i=1 . . . n. Such queries can be defined as filters or as temporary, comparison queries, or in any other convenient way. Let the corresponding frequency of selector s be f_{i,s}. Let the aggregate index be k so that an aggregate of selector frequencies, selector values, or selector counts for query i can be designated as a_{k,i}. Then the Column Defining Function F would define the column cell value, cₛ, at selector s, by

cₛ=F(f_{1,s},f_{2,s},f_{3,s}, . . . ,a_{1,i},a_{2,i},a_{3,i} . . . )

The function F is used to calculate each element of the column to determine the cell values. So for example if Q₁, Q₂, Q₃, Q₄, were 4 queries and the function F defining a column was given by F=(f_{1,s}+f₂ₛ)/(f_{1,s}+f₂ₛ), then for each selector s in the group the resulting cell value in the column would be (f_{1,s}+f₂ₛ)/(f_{1,s}+f₂ₛ).

It may be convenient to define some often used standard functions as single-click choices.

When a user chooses to display a column after first imposing an additional query, the defined column can show its cell values independently of the user imposed query, or it can show its values with the Column Defining Queries conjoined with the user imposed query. In addition, it is often desirable to have the user imposed query be conjoined only with some of the Column Defining Queries. For example, in the case of Column Defining Queries where one query defines the numerator the other the denominator, the user imposed query may be conjoined with the denominator query, but not with the numerator query. The user may choose from such options.

More generally, it is convenient sometimes to conjoin a modified user query with some or all of the Column Defining Queries. The user can be shown the various options and be allowed to choose. A user or an installer of the system can also choose to have the modifications of the user imposed query be made automatically by the client, based on exclusion groups or exclusion selectors. This means that if an exclusion selector is part of the user imposed query, the modification removes the exclusion selectors from the query before conjoining it with a Column Defining Query. In general, such exclusion selectors can be different for each Column Defining Query.

Columns can be defined by a user and can also be pre-defined through configuration.

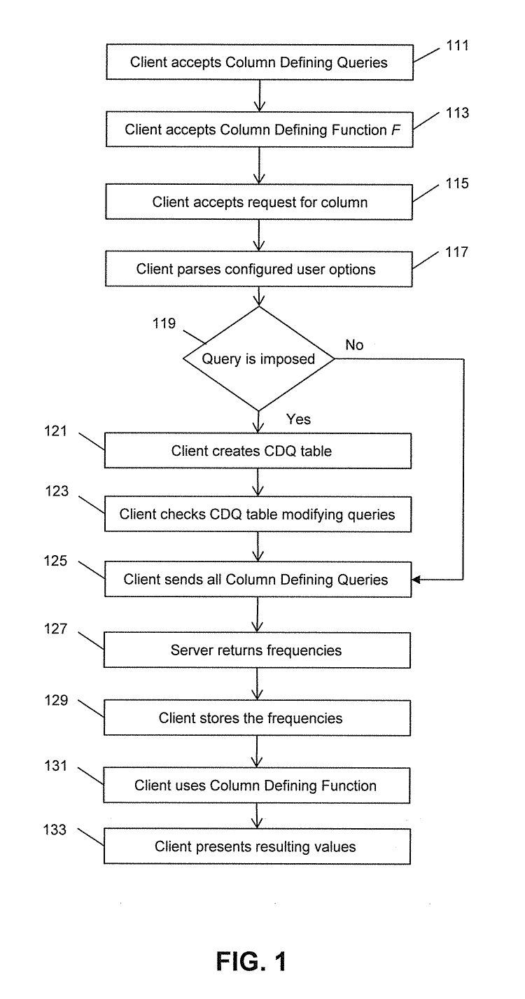

The method steps creating a calculated column can be carried out in many ways. A flow diagram of a process for creating a calculated column is shown in FIG. 1. The process of FIG. 1 is shown as being performed by a processor of a client computer executing program instructions of a client program, and a processor of a server computer coupled to the client computer by a network. As shown in FIG. 1:
1. A client program accepts the user defined Column Defining Queries in block 111.
2. The client program accepts the user defined Column Defining Function F in block 113.
3. The client program accepts from the user a request to have the column presented in block 115.
4. The client program parses the configuration file and user options in block 117.
5. In block 119, the process determines if a user has imposed a query. If so, the process continues to block 121, otherwise the process goes to block 125, go to step 8.
6. If the user has imposed a query, in block 121 the client program creates a CDQ table of each Column Defining Query and the exclusion selectors which should be removed from the user imposed query before conjoining it with the Column Defining Query. If exclusion selectors have not been defined, the CDQ table will have no entries.
7. In block 123, the client program checks the CDQ table and modifies the Column Defining Queries by conjoining each with a suitably modified user imposed query.
8. The client sends all Column Defining Queries as a composite request to the server in block 125.
9. In block 127, the server processes the request and returns to the client the frequencies associated with each selector in the group in which the column is to be presented, for each Column Defining Query.
10. In block 129, the client stores, in the Column Defining Table, the frequencies returned by the server.
11. In block 131, the client uses each row of the Column Defining Table with the Column Defining Function to calculate the cell value corresponding to the row. The client checks each value in the calculation for problems such as division by zero and notes the cells for which a problem is found.
12. In block 133, the client presents, for example using a display device of the client computer, the resulting values associated with each selector in the column and either presents the problem values using identifiers of the problem, or presents an empty cell.

Practitioners of the arts will recognize that there are other ways ordering and of implementing the described method steps. and that a stand-alone, rather than a client-server system may be used.

Query Evaluation Methods

There are several methods of evaluating queries using an associative matrix. We focus here on the evaluation of selector frequencies, because that and the numeric selector values is all that is needed to perform all calculations of data analysis.

Query evaluation can be divided into two steps:
1. Determine the matching items
2. Determine the item counts associated with each selector, the selector frequencies.

A possible implementation of the association matrix uses arrays of vectors. Each vector being itself an array. There are two simple structures which can easily store the associations as vectors.
1. As a bit array, or bit vector;
2. As an array of numbers, called an ID array, or ID vector.

Both are useful in different parts of the query evaluation process. A matrix storing the association between a set of selectors and a set of items can be visualized as a table in which each row represents a selector, each column represents an item, and each cell stores a one bit number, zero if there is no association and 1 if there is one. This means that each selector is represented by a row number and each item by a column number. In all operations involving selectors and items it is usually convenient to use these numbers as identifiers of the respective elements.

The n^{th} row vector of this matrix represents the selector with ID n and stores its associations with items represented by its components. Similarly the m^{th} column vector stores associations between the item with ID m and selectors represented by its components.

Each vector can also be represented as an array of 32 or 64 bit numbers, each number representing the associated element's identifier, which is either the column or row number of the matrix. We call this the ID vector, while the other representation is called a bit vector, or binary vector and is usually implemented as a bit array. The length of the ID vector depends on the number of elements associated with the respective entity represented by the vector.

The length of the bit vector is the same number of bits as the total number of the respective elements. In most applications the average number of associated elements is a very small fraction of the total number of these elements, that is the great majority of the vectors are sparse. In that case storing the associations in bit vectors is inefficient. However the use of bit vectors in query evaluation can improve performance.

The following describes a typical evaluation of a query which gives the selector frequencies of all selectors. We can use a vector of counts, referred to as the counting vector, to contain the result of all selector frequencies. The counting vector has a fixed number of components and is conveniently implemented as an array in which the array's element index is the ID of a selector.

The evaluation of a Boolean query comprised of selectors can proceed as follows. The first step determines the matching items. These are best stored in an item matching vector, whose components are the IDs of the matching items. The components of the item matching vector are developed as follows. A Boolean expression comprised of selectors is the usual query. The following describes the two principal Boolean operations, conjunctions and disjunctions, in a query evaluation process.

A conjunction of a pair of selectors is usually carried out with the vectors represented as ID vectors with the component IDs of each vector in sorted order. This allows the use of the so-called zig-zag method of comparing the components. When two components are the same, the component (being an ID of a matching item) is written to an item matching vector. The initial item matching vector can be one of the two vectors. Any other selector which is to be conjoined is then conjoined with this item matching vector using the zig-zag method.

An alternative and sometimes faster method is to have or convert one vector (of the pair to be conjoined) as a bit vector while the other is an ID vector and will be used to store the result vector. Each ID vector component can be used to address the corresponding bit vector, which is checked and if zero, that component is overwritten in the ID result vector. At completion of the conjunction, the bit vector is cleared and the next ID vector to be conjoined is used to set the bits in the bit vector and the process between the result vector and the bit vector is repeated for the next conjunction. This method does not require the ID vectors to have their components sorted.

When a set of selectors is to be disjoined, a method can use a bit vector as the output vector. Then each selector vector to be disjoined, in the form of an ID vector, uses each of its ID components to address a bit in the output bit vector and sets the corresponding bit. After all disjunctions, the bit vector components define the IDs of the matching items and so the components of the item matching vector. This method also does not require the ID vectors to have their components sorted.

In the second step of the query evaluation process, the process calculates the counts of items associated with each selector. So the output vector for this part is the counting vector. The set of matching items are the components of the result vector from the first step in the query evaluation process. A possible method of evaluating the second step is to use the matrix in the transposed representation, that is as an array of item vectors. Each of the matching items identifies an item vector whose components are the selectors associated with the item. For this part we need the count of items associated with each selector. This can be obtained by using the components of each item vector in the ID form as indexes of the array elements in the counting vector and incrementing the count stored in each accessed array element. The resulting counting vector contains the frequencies of each selector.

It is usual to disable the zero frequency selectors from subsequently being added conjunctively to the query and only the non-zero frequency selectors are usually made available for this purpose because choosing a zero frequency selector would result in zero matching items—an empty search result.

Although the invention has been discussed with respect to various embodiments, it should be recognized that the invention comprises the novel and non-obvious claims supported by this disclosure.

What is claimed is:

1. A computer based method of calculating numerical values associated with selectors, comprising:
receiving a plurality of user defined queries, the user defined queries specifying a plurality of selectors;
calculating frequencies of the selectors, each selector frequency being a count of items, or structures within items, associated with the selector and matching the query, the queries being executable on a structure containing associations between selectors and items, the associations having been extracted from data prior to query execution;
performing mathematical operations on frequencies associated with one or more selectors.

2. The method of claim 1 wherein a plurality of the associations between selectors and items, or entities, are stored as either present or absent.

3. The method of claim 1 wherein the associations between selectors and items, or entities within items, are stored as an array.

4. The method of claim 1 further comprising using values of numerical selectors.

5. The method of claim 1 wherein the structure containing associations between selectors and items can be represented by a multi-partite graph, in which vertices represent the items, entities, and selectors, and non-directed edges represent the associations and in which the selectors are adjacent to entities when present, and to items when no entities present, and the entities, when present, are adjacent to items.

6. The method of claim 5 wherein the calculation of selector frequencies comprises the count of items and the count of entities.

7. The method of claim 3 wherein the array comprises components which are either one or zero.

8. The method of claim 1 wherein the associations are stored in a plurality of different data structures.

9. A computer implemented method of performing calculations on data in a computer system comprising:
extracting associations between selectors, items, and entities;
storing said associations in an associations data structure;
using the associations data structure to evaluate a plurality of queries, with results of the evaluations comprised of selector frequencies;
performing calculations using the selector frequencies from a plurality of queries.

10. The method of claim 9 wherein the associations data structure can be represented by a multi-partite graph, in which vertices represent the items, entities, and selectors, and non-directed edges represent the associations and in which the selectors are adjacent to entities when present, and to items when no entities present, and entities, when present, are adjacent to items.

11. The method of claim 9 wherein the selector frequencies comprises the count of items and the count of entities.

12. The methods of claim 9 wherein queries from the said plurality of queries are conjoined with a narrowing query before the said plurality of queries is evaluated.

13. The methods of claim 9 wherein a narrowing query is modified so as to avoid empty matching results and is then conjoined with queries from the said plurality of queries, which are then evaluated.

14. The method of claim 9 wherein the associations data structure is comprised of an array and the array comprises an identifier number array.

15. The method of claim 13 wherein the array comprises a bit array.

16. The method of claim 9 wherein the associations data structure comprises a plurality of different data structures.

17. The method of claim 14 wherein the array comprises components which are either one or zero.

18. A computer implemented method, using associations between selectors and parts of data, to perform a calculation, said associations extracted from the data and stored in an association structure which stores an association as either present or absent, comprising: calculating a result using a plurality of selector frequencies for each of a plurality of selectors, the frequencies derived from the association structure.

19. The method of claim 18 wherein the association is stored in an array.

20. The method of claim 19 wherein the array comprises integer components as identifiers of the associated elements.

21. The method of claim 20 wherein the array comprises bit components as identifiers of the associated elements.
